(19) United States
(12) Patent Application Publication
(10) Pub. No.: US 2005/0222903 A1
(43) Pub. Date: Oct. 6, 2005

(54) Rendering content-targeted ads with e-mail

(76) Inventors: Paul Buchheit, Mountain View, CA (US); Yingwei Claire Cui, Cupertino, CA (US); Jing Lim, Santa Clara, CA (US); Narayanan Shivakumar, San Jose, CA (US); Michael Tsao, San Mateo, CA (US); Russ Tuck, San Jose, CA (US)

Correspondence Address: STRAUB & POKOTYLO, 620 TINTON AVENUE, BLDG. B, 2ND FLOOR, TINTON FALLS, NJ, 07724, US

(21) Appl. No.: 10/814,104

(22) Filed: Mar. 31, 2004

(51) Int. Cl. G06F 17/60

(52) U.S. Cl. 705/14

(57) ABSTRACT

An asynchronous and opportunistically available scheme under which a user's e-mail (or a document including e-mail content) is rendered immediately, and later updated with appropriate advertisements if and when they became available, is described. This scheme ensures that the availability of advertisements will not adversely affect the rendering of the e-mail content. For example, a Web-based e-mail server may facilitate the serving of advertisements with e-mail by (a) accepting a request for a document including e-mail, (b) generating a request identifier, (c) serving the requested document in association with the request identifier, and (d) obtaining at least one ad relevant to content of the e-mail. The Web-based e-mail server may further (e) store the obtained ad(s), (f) accept an ad request, (g) read the stored ad(s) using information from the ad request, and (h) serve the ad(s).

### § 1. BACKGROUND OF THE INVENTION

§ 1.1 Field of the Invention

The present invention concerns advertising. In particular, the present invention concerns expanding the opportunities for advertisers to target their ads.

§ 1.2 Related Art

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.) Query keyword relevant advertising has been used by search engines, such as the AdWords advertising system by Google of Mountain View, Calif. Similarly, content-relevant advertising systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Bucheit as inventors, and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Bucheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example.

The Sprinks service offered by “About” of New York, N.Y. allows advertisers to insert ads targeted to topics from a predetermined list in e-mail using dynamically generated images with client-side image maps and cookies. U.S. patent application Ser. No. 10/699,607 (incorporated herein by reference and referred to as “the '607 application”) titled “SERVING CONTENT TARGETED ADS IN E-MAIL, SUCH AS E-MAIL NEWSLETTERS”, filed on Oct. 31, 2003 and listing Alexander Paul Carobus, Alex Roetter and Ben Davenport as inventors, describes methods and apparatus for serving ads relevant to information in e-mail documents, such as e-mail newsletters.

U.S. patent application Ser. No. 10/452,830 (incorporated herein by reference and referred to as “the '830 application”) titled “SERVING ADVERTISEMENTS USING INFORMATION ASSOCIATED WITH E-MAIL”, filed on Jun. 2, 2003 and listing Jeffrey A. Dean, Georges R. Harik and Paul Bucheit as inventors, describes methods and apparatus for serving ads relevant to information in e-mail documents. The '830 application describes alternative ways of serving ads with e-mail, including using applications on a sender client device, a recipient client device, a Web-based e-mail server, etc. In any event, the ads are targeted to relevance information (e.g., concepts, topics, etc.) that may be extracted from the content of (or other information derivable from) the e-mail.

Hotmail and Yahoo both have Web-based e-mail services that display advertisements, either as part of the e-mail content itself, or adjacent to the display of the e-mail on the user's Web browser screen. Unfortunately, these services have a number of undesirable characteristics. For example, embedding advertisements in the bodies of e-mail is often annoying to the user, particularly if the ads are not useful to the user. Not only do such advertisements detract attention from the actual e-mail content, but they actually lower the value of the e-mail service as a whole, because it is difficult or impossible to send an e-mail that has not been modified to include advertising. The user is less likely to be receptive to advertisement subject matter that is unrelated to what is currently on their mind while reading the e-mail. Sadly, the Hotmail and Yahoo e-mail advertisements are not targeted to the content of the e-mail. Furthermore, the display of banner advertisements next to a Web-mail display is an all-or-nothing proposition; either the ad server is working and advertisements are shown, or it isn't and advertisements aren't shown. Moreover, if the ad server is overloaded and slow to respond, it becomes a bottleneck that slows the display of all e-mail content.

In view of the foregoing, it would be useful to improve advertisements rendered with e-mail. For example, regardless of the system used to serve ads with e-mail, it may be desirable to have the ads be relevant since users are more likely to ignore irrelevant advertisements. Thus, for example, an e-mail discussing flower arrangement should trigger advertisements related to flower arrangement. Moreover, since e-mail content is generally highly personal, the user is more likely to want to read it quickly and without interruption than if they were simply browsing publicly available web content. It may be desirable to have the rendering of the e-mail content be independent of the serving and rendering of the ads so that the ads are non-intrusive. It may also be desirable to minimize, or at least reduce or manage communications and/or computational bandwidth.

### § 2. SUMMARY OF THE INVENTION

Embodiments consistent with the present invention may be used to ensure that the availability of advertisements does not adversely affect the rendering of the e-mail content by providing an asynchronous and opportunistically available scheme under which the user's e-mail is rendered, and later updated with appropriate advertisements if and when they became available.

Exemplary embodiments consistent with the present invention may facilitate the serving of advertisements with e-mail by (a) accepting a request for a document including e-mail content, (b) generating a request identifier, (c) serving the requested document in association with the request identifier, and (d) obtaining at least one ad relevant to content of the e-mail. Such exemplary embodiments may be included in a Web-based e-mail server for example. Such exemplary embodiments may further (e) store the obtained ad(s), (f) accept an ad request, (g) read the stored ad(s) using information from the ad request, and (h) serve the ad(s).

In at least some embodiments consistent with the present invention, the ad request may have been sourced by a client device when it rendered the requested document, or after it rendered the requested document. The client device may be a browser for example.

In at least some embodiments consistent with the present invention, the ad request may include the request identifier. The request identifier may be used to lookup the ad(s) stored in association with the request identifier.

In at least some embodiments consistent with the present invention, the act of serving the requested document in association with the request identifier may be performed by a first thread and the act of obtaining at least one ad relevant to content of the e-mail may be performed by a second thread. The execution of the first thread may be independent of the execution of the second thread.

Exemplary embodiments consistent with the present invention may facilitate the serving of advertisements with e-mail by (a) requesting a document including e-mail content, (b) accepting the document, (c) rendering the document, (d) requesting at least one ad relevant to the e-mail content of the document, (e) receiving the ad(s), and (f) rendering the ad(s) in association with the rendered document, where the ad(s) are rendered after the e-mail content of the document has already been rendered. Such exemplary embodiments may be included in a Web browser for example.

In at least some embodiments consistent with the present invention, the accepted document includes a request identifier and the act of requesting at least one ad relevant to the e-mail content of the document may include generating a request including the request identifier.

In at least one embodiment consistent with the present invention, the act of requesting ad(s) relevant to the e-mail content of the document may include constructing a URL that represents a request for at least one ad. The act of requesting ad(s) relevant to the e-mail content of the document may further include instantiating an ActiveX object (or some other downloadable code executed as a component of a browser) that takes the URL and requests the ad(s) from a Web-based e-mail server that sourced the document.

In at least one embodiment consistent with the present invention, if the document is a Web page, the act of rendering the at least one ad in association with the rendered e-mail content of the document may include manipulating a document object model of the Web page to render the ads.

### § 3. BRIEF DESCRIPTION OF THE DRAWINGS

FIG. 1 is a block diagram illustrating an exemplary on-line advertising environment in which, or with which, the present invention may be used.

FIG. 2 is a flow diagram of an exemplary method that may be used by a Web-based e-mail server to serve ads in a manner consistent with the present invention.

FIG. 3 is a flow diagram of an exemplary method that may be used by client device browser to render content-relevant ads with e-mail in a manner consistent with the present invention.

FIG. 4 is block diagram of a machine that may perform one or more operations and store information used and/or generated in a manner consistent with the present invention.

FIG. 5 is a messaging diagram illustrating communications among various exemplary operations of an exemplary embodiment of the present invention.

FIG. 6 is an exemplary browser window, consistent with the present invention, including e-mail body content and text-based, content-relevant ads.

### § 4. DETAILED DESCRIPTION

The present invention may involve novel methods, apparatus, message formats, and/or data structures for serving content-relevant ads with e-mail. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

In the following, environments in which, or with which, the present invention may operate are described in § 4.1. Then, exemplary embodiments consistent with the present invention are described in § 4.2. Examples of operations are provided in § 4.3. Finally, some conclusions regarding the present invention are set forth in § 4.4.

§ 4.1 Environments in which, or with which, the Present Invention May Operate

§ 4.1.1 Definitions

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has a unique, addressable, storage location and can therefore be uniquely identified by this addressable location. A universal resource locator (URL) is a unique address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer or Netscape), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

§ 4.1.2 Environments in which, or with which, the Present Invention May Operate

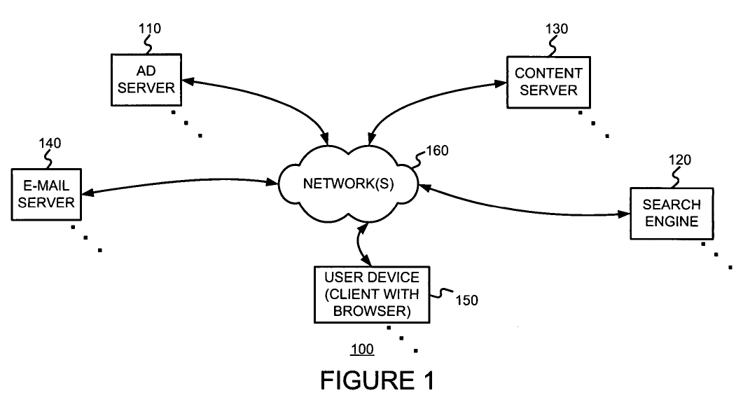

FIG. 1 illustrates exemplary environments in which, or with which, the present invention may be used. A user device (also referred to as a “client” or “client device”) 150 may include a browser facility (such as the Explorer browser from Microsoft, the Opera Web Browser from Opera Software of Norway, the Navigator browser from AOL/Time Warner, etc.), an e-mail facility (e.g., Outlook from Microsoft), or any other software application or hardware device used to render content. A search engine 120 may permit user devices 150 to search collections of documents (e.g., Web pages). A content server 130 may permit user devices 150 to access documents. A Web-based e-mail server (such as Hotmail from Microsoft Network, Yahoo Mail, etc.) 140 may be used to provide e-mail functionality to user devices 150. An ad server 110 may be used to serve ads to user devices 150. The ads may be served in association with search results provided by the search engine 120. Content-relevant ads may be served in association with content provided by the content server 130, and/or e-mail supported by the e-mail server 140 and/or user device 150 e-mail facilities. Thus, the as server 110 may be a content-relevant ad server, such as those described in the '427 and '900 applications.

As discussed in the '900 application (introduced above), ads may be targeted to documents served by content servers. Thus, a content server 130 that receives requests for documents (e.g., articles, discussion threads, music, video, graphics, search results, Web page listings, etc.), and retrieves the requested document in response to, or otherwise services, the request may consume ads. The content server 130 may submit a request for ads to the ad server 110. Alternatively, or in addition, a user device 150 may submit such a request. Alternatively, or in addition, a Web-based e-mail server 140 may submit such a request. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geolocation information, end user local time information, document information, etc.

The content server 130, Web-based e-mail server 140, and/or user device 150 may combine the requested document with one or more of the advertisements provided by the ad server 110. This combined information including the document content and advertisement(s) is then forwarded towards, and/or rendered on, the end user device 150 that requested the document, for presentation to the user. Finally, the content server 130 or Web-based e-mail server 140 may transmit information about the ads and how, when, and/or where the ads are to be rendered (e.g., position, clickthrough or not, impression time, impression date, size, conversion or not, etc.) back to the ad server 110. Alternatively, or in addition, such information may be provided back to the ad server 110 by some other means. Consistent with the present invention, the ad server 110 may store ad performance information.

A search engine 120 may receive queries for search results and may consume ads. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 120 may submit a request for ads to the ad server 110. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as end user local time information, geolocation information, whether the query came from an affiliate and an identifier of such an affiliate), and/or information associated with, or based on, the search results. Such information may include, for example, identifiers related to the search results (e.g., document identifiers or “doclDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 120 may combine the search results with one or more of the advertisements provided by the ad server 110. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 120 may transmit information about the ad and when (e.g., end user local time), where (e.g., geolocation), and/or how the ad was to be rendered (e.g., position, click-through or not, impression time, impression date, size, conversion or not, etc.) back to the ad server 110. Alternatively, or in addition, such information may be provided back to the ad server 110 by some other means.

The Web-based e-mail server 140 may be thought of, generally, as a content server in which a document served is simply an e-mail. Further, e-mail applications (such as Microsoft Outlook for example) may be used to send and/or receive e-mail. Therefore, a Web-based e-mail server 140 or a client device 150 application may be thought of as an ad consumer. Thus, e-mails may be thought of as documents, and targeted ads may be served in association with such documents. For example, one or more ads may be served in, under, over, or otherwise in association with an e-mail. It should be appreciated by those skilled in the art that the invention is not limited to email, but rather, may be implemented with other types of electronic messaging as well, such as on-line groups, blogs, other online message postings, instant messaging, etc.

The various servers may exchange information via one or more networks 160, such as the Internet for example.

§ 4.2 Exemplary Embodiments

§ 4.2.1 Overview

Consistent with the present invention, an e-mail server (referred to in the specification as a “Web-based e-mail server” without loss of generality) may interact with a content rendering application (referred to in the specification as a “Web browser” without loss of generality) by serving a document (referred to in the specification as a “Web page” without loss of generality) in two stages —a “content” stage, and an “ad” stage. Some parts of each of these stages may execute independent of the performance of parts of the other stage. Examples of each of these stages are described below.

The content stage may begin conventionally with a request from the Web browser to display a Web page including one or more e-mail bodies. The Web-based e-mail server may execute two threads—a content serving thread and an ad acquisition thread. Before, after, or during the generation of a response, the Web-based e-mail server may (i) identify sections of the e-mail bodies that are likely to contain source content for selecting relevant advertisements (for example, the subject and body, but not the user's signature or the from/to address), (ii) generate a unique identifier (referred to as a “fingerprint” in the specification without loss of generality) identifying this particular request, (iii) provide the fingerprint and source content to the ad acquisition thread, (iv) start the ad acquisition thread, and (v) continue serving the requested page, which contains a copy of the fingerprint, under the content thread.

Under the ad acquisition thread, the Web-based e-mail server may request that the content-relevant ads server (CAS) provide advertisements appropriate for the source content (e.g., it may execute a remote procedure call (RPC) to the CAS). This RPC may take many hundreds of milliseconds to complete, or it may fail entirely. If the request takes too long, it may be terminated, and the ad acquisition thread may exit with an empty result. If the request fails, the ad acquisition thread may exit with an empty result. If the request succeeds, the ad acquisition thread may take the result, which may contain the content of one or more targeted ads. The Web-based e-mail server may then convert the resulting one or more ads to a format that is convenient for delivery to the user's Web browser. The Web-based e-mail server may then store the one or more ads (e.g., in a lookup table with the fingerprint serving as a primary key such that the stored one or more ads may be retrieved using the fingerprint). Finally, the ad acquisition thread exits.

The ad stage may begin when the Web browser renders the Web page delivered to it from the Web-based e-mail server during the content stage. Recall that this page includes the fingerprint identifying the ad request corresponding to the page. The Web browser may then request the ads (e.g., from the Web-based e-mail server). For example, the Web browser may use Javascript to construct a URL that represents a request for the ads. For example, the Javascript code may instantiate an ActiveX object that takes the URL and requests the ads from the Web-based e-mail server.

When the Web-based e-mail server receives the ad stage request from the browser, it may use the fingerprint to lookup the associated one or more ads in the lookup table. If the Web-based e-mail server finds an entry in the table corresponding to the request, it may return the result that has already been stored in the table, or block (wait) while the request completes. Note that blocking at this point is acceptable because the portion of the Web page containing the e-mail content has already been rendered on the user's browser. Once the requested ad(s) is available, the Web-based e-mail server responds with it.

When the Web browser receives the one or more content-relevant ads, it may render them to the user. For example, the browser may use Javascript (e.g., from the initial page, in response to the ad request, etc.) to format the ad (e.g., to conform to normal Google ad appearance). Finally, the Javascript may manipulate the page's document object model (DOM) to render the ads for the user.

Selections may be tracked in various ways, such as those described in the '427, '900, '607 and '830 applications introduced above.

§ 4.2.2 Exemplary Methods

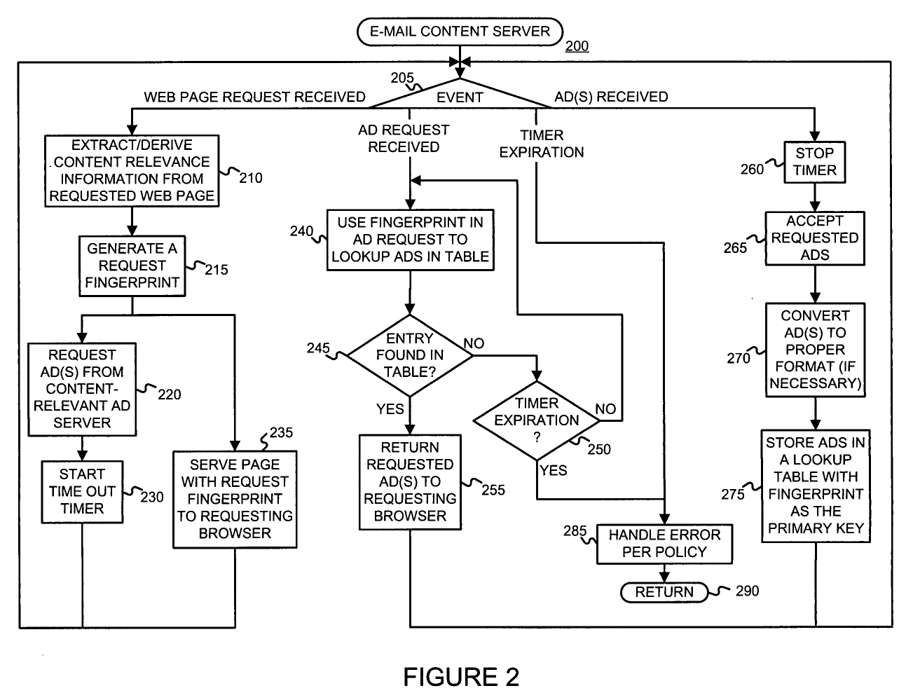

FIG. 2 is a flow diagram of an exemplary method 200 that may be used by a (Web-based e-mail) content server to serve ads in a manner consistent with the present invention. As indicated by block 205, various branches of the method 200 may be performed in response to various events. For example, if an e-mail Web page request is received, the method 200 may execute one or more threads. More specifically, the method 200 may extract and/or derive content relevance information from the requested Web page (Block 210) and a unique request identifier (referred to as a “request fingerprint” in the specification without loss of generality) is generated (Block 215). One or more threads of the method 200 may be used to request one or more ads from a content-relevant ad server (Block 220) and start a timeout timer (Block 230), as well as serve the Web page with the request fingerprint to the browser that sourced the request (Block 235). The method 200 then returns to event block 205. Thus, the left sub-branch of the method 200 may correspond to an ad acquisition thread while the right sub-branch of the method 200 may correspond to a content serving thread.

Referring again to event block 205, if one or more ads are received (e.g., in response to request 220), the timeout timer is stopped (Block 260) and the requested one or more ads are accepted (Block 265). If necessary, the ads may be reformatted (e.g., so that they may be rendered with the Web page). (Block 270) The one or more ads may then be stored (e.g., in a table with the request fingerprint used as a primary key to lookup the ads). (Block 275) The method 200 then returns to event block 205

Referring once again to event block 205, if an ad request, which should include a request fingerprint (Recall block 235.), is received, the requested ad(s) are retrieved (e.g., the request fingerprint is used to lookup the one or more ads previously stored). (Block 240) If the ad(s) are found, they are returned to the requesting browser. (Blocks 245 and 255) If, on the other hand, the ad(s) are not found, it is determined whether or not the timeout timer has expired. (Blocks 245 and 250) If not, the method 200 branches back (perhaps after a delay) to block 240. Other ways of waiting for the ads may be used. If, on the other hand, the timer has expired, an error event may be handled in accordance with a policy (Block 285) before the method 200 is left (Node 290).

Referring one last time to event block 205, if the timeout timer expires, an error event may be handled in accordance with a policy (Block 285) before the method 200 is left (Node 290).

Referring back to block 235, the Web page may include one or more e-mail bodies. Referring back to block 210, the content-relevant information may be information used by the content-relevant ad server to enable it to serve content-relevant ads. For example, sections of the e-mail bodies that are likely to contain source content for selecting relevant advertisements (for example, the subject and body, but perhaps not the user's signature or the sender and recipient addresses) may be extracted. Referring back to block 220, the request may be a remote procedure call (RPC) to the content-relevant ads server, requesting advertisements appropriate for the source content. This RPC may take many hundreds of milliseconds to complete, or it may fail entirely. If the RPC takes too long, the ad acquisition thread may be killed and may be left with an empty result. Thus, referring back to blocks 230, 250 and 285, the timeout timer may be set to a predetermined time. In at least one embodiment consistent with the present invention, the predetermined time may be a time from about half a second to about 2 seconds (e.g., about 1,250 milliseconds). Similarly, if the RPC fails, the ad acquisition thread may be left with an empty result. If the RPC succeeds, the ad thread accepts, possibly reformats, and stores the ad(s) before the ad acquisition thread exits.

Referring back to block 245, if the Web-based e-mail server finds the requested ad(s), it either returns the ad(s) that has already been stored in the table, or blocks while the request completes. Note that blocking at this point is acceptable because the portion of the Web page containing the e-mail content has already been rendered on the user's browser. Thus, referring to blocks 240, 245 and 250, once the requested ad(s) is available, the Web-based e-mail server can respond to the browser request.

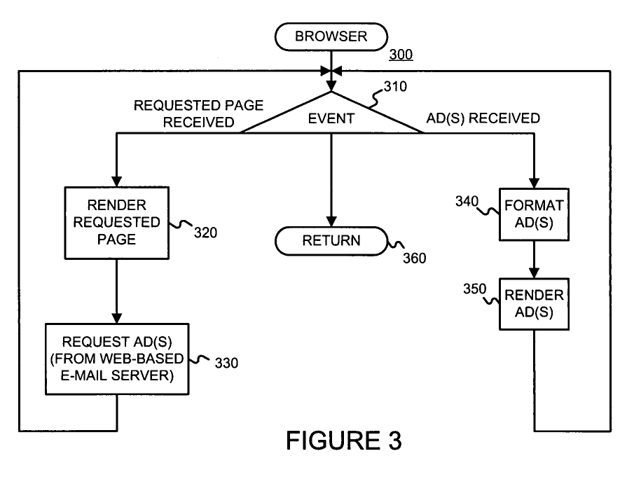

FIG. 3 is a flow diagram of an exemplary method 300 that may be used by client device browser to render content-relevant ads with e-mail in a manner consistent with the present invention. As indicated by block 310, various branches of the method 300 may be performed in response to various events. For example, if a requested page is received, the received page is rendered (Block 320), and one or more ads may be requested (e.g., from the Web-based e-mail server) (Block 330). The method 300 then returns to event block 310.

Referring back to event block 310, if one or more ads are received, they are formatted, if necessary, (Block 340), and rendered (Block 350). The method 300 then returns to event block 310.

Referring back to blocks 320 and 330, an ad stage may begin when the Web browser renders the Web page delivered during the content stage. In one embodiment consistent with the present invention, this Web page may include the fingerprint identifying the ad request corresponding to the Web page. In one embodiment consistent with the present invention, the browser may use Javascript to construct a URL that represents a request for the ads. In such an embodiment, the Javascript code may instantiate an ActiveX object (or some other downloadable code executed as a component of a browser) that takes the URL and requests the ads from the Web-based e-mail server.

Referring back to blocks 340 and 350, in at least one embodiment consistent with the present invention, when the Web browser receives the ad results (e.g., from the Web-based e-mail server), it may use Javascript to format the ad to conform to a predefined ad format (e.g., a text-based ad having a predefined format such as a lead line, one to three lines of ad copy, and a URL address, such as a normal Google ad). In such an embodiment, the Javascript may manipulate the document object model (DOM) of the Web page to render the ads for the user.

Recall from block 350 that the ad(s) may be rendered in association with the e-mail content. In at least one embodiment consistent with the present invention, the one or more as are rendered “next to” the e-mail message (or e-mail message body), but are not a part of the actual e-mail message. Unlike Yahoo, Hotmail, etc., the recipient user, when viewing their e-mail, will see one or more ads related to the e-mail message that they are viewing, but the one or more ads do not modify the e-mail message (or e-mail message body), or otherwise become part of it. With some other systems, ads actually become part of the e-mail and therefore modify the e-mail message itself. In such systems, when the message is re-sent, other recipients (who may not use Yahoo mail, for example) will be burdened with the ads. Also, the existence of such ads in messages may trigger unwanted spam detection/filtering mechanisms on the other end. In this at least one embodiment, these problems can be avoided.

§ 4.2.3 Exemplary Apparatus

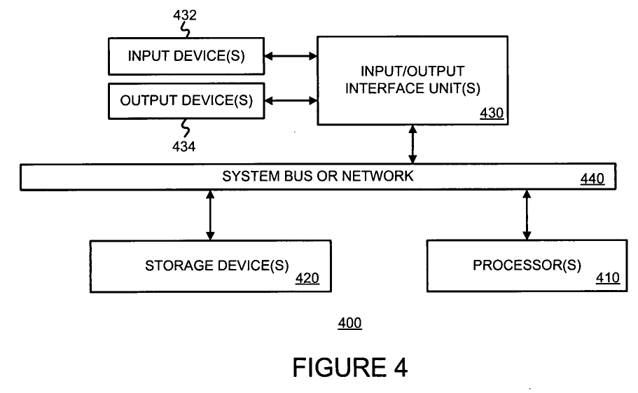

FIG. 4 is high-level block diagram of a machine 400 that may perform one or more of the operations discussed above. One or more such machines 400 may be used as a content-relevant ad server, a separate server, client devices, etc. The machine 400 basically includes one or more processors 410, one or more input/output interface units 430, one or more storage devices 420, and one or more system buses and/or networks 440 for facilitating the communication of information among the coupled elements. One or more input devices 432 and one or more output devices 434 may be coupled with the one or more input/output interfaces 430.

The one or more processors 410 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 420 and/or may be received from an external source via one or more input interface units 430.

In one embodiment, the machine 400 may be one or more conventional personal computers. In this case, the processing units 410 may be one or more microprocessors. The bus 440 may include a system bus. The storage devices 420 may include system memory, such as read only memory (ROM) and/or random access memory (RAM). The storage devices 420 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 432, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 410 through an appropriate interface 430 coupled to the system bus 440. The output devices 434 may include a monitor or other type of display device, which may also be connected to the system bus 440 via an appropriate interface. In addition to (or instead of) the monitor, the personal computer may include other (peripheral) output devices (not shown), such as speakers and printers for example.

Each of the Web-based e-mail server 140, the user device 150, etc., may be embodied by one or more such machines 400.

§ 4.2.4 Refinements And Alternatives

Although the embodiments described above use a single identifier or fingerprint to associate various information, bindings or associations created using additional identifiers may also be used. For example, the request fingerprint need not be transmitted to and from the content-relevant ad server if the request and reply are done at one time. Although the content-relevant ads were targeted to the content of an (e.g., individual) e-mail in some of the exemplary embodiments described above, embodiments consistent with the present invention may be used with content-relevant ads targeted to e-mail content in general, such as content from some group or collection of e-mails. For example, e-mail content may include content from a group of (e.g., all) e-mails belonging to a thread of related messages. As another example, e-mail content may include content from a “conversation view” such as described in U.S. patent application Ser. Nos. ______ and ______ (incorporated herein by reference), Attorney Docket No. GP-281-00-PR and GP-281-01-PR, entitled “EMAIL SYSTEM WITH CONVERSATION-CENTRIC USER INTERFACE” and “EMAIL CONVERSATION MANAGEMENT SYSTEM”, respectively, both of which are filed on Mar. 31, 2004 and listing Paul Buchheit et al. as inventors. Thus, the content-relevant ad targeting is not necessarily for a single, individual e-mail message, but may be for a number of e-mail messages.

Security

In at least some embodiments consistent with the present invention, the ad server 110 is not generally accessible to devices on the Internet, but interacts directly with the e-mail server 140. Thus, the networks 160 may include a private network, or a virtual private network (VPN) over which the e-mail server 140 and ad server 110 may communicate.

Tracking User actions with respect to ads

Other schemes for determining user actions, such as those described in U.S. patent application Ser. No. 10/653,899 (incorporated herein by reference) titled “SYSTEMS AND METHOD FOR DETERMINING USER ACTIONS,” filed on Sep. 4, 2003, and listing Alex Roetter and Deepak Jindal as inventors (Attorney Docket No. 0026-0040) may be used instead of, or in addition to, the techniques described above.

The Rendering of other Content-Relevant Information

Other content-relevant information may be rendered instead of, or in addition to content relevant ads. Such “other content” might be related suggested queries (e.g. “Try a search for ______ ”), news articles (or excerpts or summaries thereof), reviews (or excerpts or summaries thereof), etc. The “other content” could be presented in various ways or forms. For example, it may be presented as a suggested query, “related information,” etc. The “other content” might have the same format and/or footprint as the ads, although this is not necessary. Thus, for example, if the ads are text-based ads, the “other content” may be text-based. In at least one embodiment consistent with the present invention, text-based “other content” may include about one to four lines of title (e.g., bolded and/or underlined), about three lines of text, and a URL line (which may include a link to another document).

There may be various conditions or circumstances under which the other content-relevant information is rendered. For example, in at least some embodiments consistent with the present invention, the “other content” may be rendered independently of the rendering of content relevant ads. In such embodiments, for example, the “other content” may be rendered (a) whenever available, or (b) only if it has a score (e.g., determined using one or more of relevance, past user interest, source reliability, expected user interest, etc.) that exceeds some threshold, etc. In at least some other embodiments consistent with the present invention, the rendering of the “other content” may depend on the rendering of the ads. In such other embodiments, for example, the “other content” may be rendered (a) if there are available ad spots that weren't used, (b) if the “other content” is more relevant than the ads (e.g., by a predetermined margin), (c) if there are available ad spots and the “other content” has a score exceeding a threshold, etc.

§ 4.3 Examples of Operations in an Exemplary Embodiment

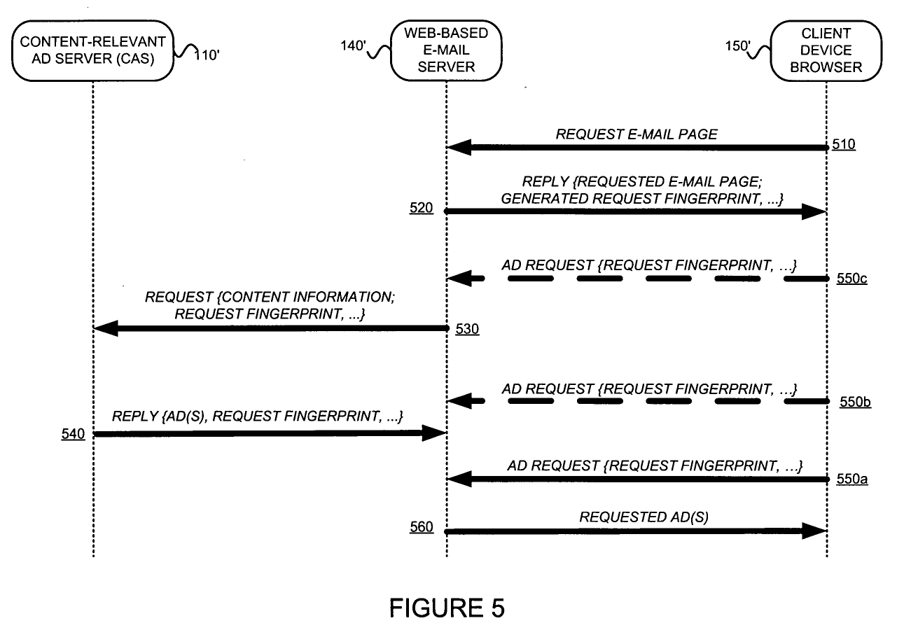

FIG. 5 is a messaging diagram illustrating how information may be exchanged or communicated among various exemplary operations in an exemplary embodiment of the present invention. Client device browser 150′ communicates a request 510 for an e-mail page to Web-based e-mail server 140′. The Web-based e-mail server 140′ then sends a reply 520, which may include the requested e-mail page and a request fingerprint, back to the client browser device 150′.

At some time after the Web-based e-mail server 140′ receives the request 510, it submits a request 530 for ads, which may include content information and the request fingerprint, to content-relevant ad sever 110′. The content-relevant ad server 110′ communicates a reply 540, which may include one or more ads and the request fingerprint, back to the Web-based e-mail server 140′.

When the client device browser 150′ receives the reply 520, it may render the requested Web page and communicate a request 550a, which may include the request fingerprint, for one or more ads back to the Web-based ad server 140′. In this way, the Web page can be rendered without having to wait for the one or more ads. The Web-based e-mail server can use the request fingerprint to lookup previously stored ad(s). If it has such ad(s), they are returned to the requesting client device browser 150′ as indicated by communication 560. Note that the ad request 550 from the client device browser 150′ may have been received at the Web-based e-mail server 140′ (a) after the Web-based e-mail server 140′ received the ad(s) as indicated by communication 550a, (b) after the Web-based e-mail server 140′ requested the ad(s) from the content-relevant ad server 110′ but before the Web-based e-mail server received the ad(s) as indicated by communication 550b, or (c) before the Web-based e-mail server 140′ even requested the ad(s) from the content-relevant ad server 110′ as indicated by communication 550c.

In an alternative embodiment, the browser 150′ may request the ads directly from the content-relevant ad server 110′. However, such an alternative embodiment may raise additional security concerns since the ad server 110′ would communicate more directly with many clients 150′, some of which may be hostile. Thus, it may be desirable, at least from a security standpoint, to have the ad server 110′ be made available to the e-mail server 140′, but not all clients 150′.

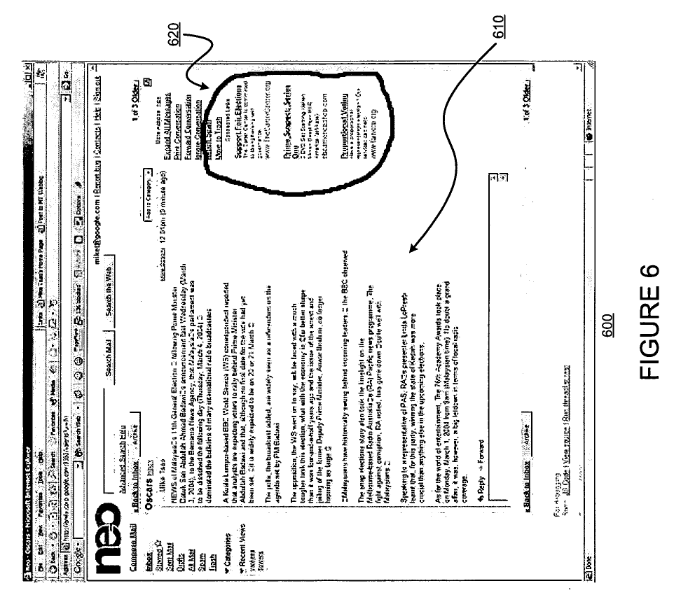

FIG. 6 illustrates an exemplary browser window 600 including e-mail content 610 and text-based content relevant ads 620.

§ 4.4 Conclusions

As can be appreciated by the foregoing, embodiments consistent with the present invention may be used to facilitate the delivery of effective advertisements to users of Web-based e-mail without annoying or upsetting users with irrelevant and useless ads, and delays to rendering e-mail. For example, embodiments consistent with the present invention facilitate the serving advertisements that are relevant to the content of the e-mail being rendered. Further, embodiments consistent with the present invention facilitate serving advertisements in a way that is non-intrusive to an e-mail user and to the rendering of the e-mail content. Because e-mail content is generally highly personal, the user is more likely to want to read it quickly and without interruption than if they were simply browsing publicly available Web content. In at least some embodiments consistent with the present invention, the availability of advertisements does not affect the rendering of the e-mail content. Otherwise, the rendering of e-mail might be delayed or hindered if the Web-based e-mail server's advertising component were temporarily unavailable or overloaded. Embodiments consistent with the present invention provide an asynchronous and opportunistically available solution that allows the user's e-mail to be rendered immediately, and then updated with appropriate advertisements if and when they became available. Further, since the ad serving occurs on recipient's end (that is, on e-mail messages being read or otherwise rendered by a particular user), there is no need for sender of e-mail to have system that supports serving ads in conjunction with email.

1. A method for facilitating the serving of advertisements with e-mail content, the method comprising:
a) accepting a request for a document including e-mail content;
b) generating a request identifier;
c) serving the requested document in association with the request identifier; and
d) obtaining at least one ad relevant to the e-mail content.

2. The method of claim 1 further comprising:
e) storing the obtained at least one ad;
f) accepting an ad request;
g) reading the stored at least one ad using information from the ad request; and
h) serving the at least one ad read.

3. The method of claim 2 wherein the ad request was sourced by a client device when it rendered the requested document.

4. The method of claim 2 wherein the ad request was sourced by a client device after it rendered the requested document.

5. The method of claim 2 wherein the ad request was sourced by a browser when it rendered the requested document.

6. The method of claim 2 wherein the ad request was sourced by a browser after it rendered the requested document.

7. The method of claim 2 wherein the act of storing the obtained at least one ad includes storing the request identifier in association with the at least one ad.

8. The method of claim 7 wherein the request identifier may be used as a primary key to lookup the associated at least one ad.

9. The method of claim 7 wherein the ad request includes the request identifier.

10. The method of claim 9 wherein the act of reading the stored at least one ad using information from the ad request uses the request identifier to lookup the associated at least one ad.

11. The method of claim 1 wherein the act of serving the requested document in association with the request identifier is performed by a first thread, and wherein the act of obtaining at least one ad relevant to content of the e-mail is performed by a second thread.

12. The method of claim 11 wherein the execution of the first thread is independent of the execution of the second thread.

13. The method of claim 1 wherein the act of obtaining at least one ad relevant to content of the e-mail includes submitting an ad request to a content-relevant ad server.

14. The method of claim 13 wherein the ad request includes the request identifier.

15. The method of claim 1 wherein the document including e-mail content represents an individual e-mail message.

16. The method of claim 1 wherein the document including e-mail content represents a group of e-mail messages.

17. The method of claim 1 wherein the document including e-mail content represents an e-mail thread output as a conversation.

18. The method of claim 1 wherein the document including e-mail content is a conversation view including a group of e-mails.

19. A method for rendering ads in association with e-mail content, the method comprising:
a) requesting a document including e-mail content;
b) accepting the document;
c) rendering the document;
d) requesting at least one ad relevant to the e-mail content of the document;
e) receiving the at least one ad; and
f) rendering the at least one ad in association with the rendered document, wherein the at least one ad are rendered after the e-mail content of the document has already been rendered.

20. The method of claim 19 wherein the accepted document includes a request identifier and wherein the act of requesting at least one ad relevant to the e-mail content of the document includes generating a request including the request identifier.

21. The method of claim 19 wherein the act of requesting at least one ad relevant to the e-mail content of the document occurs after the act of rendering the e-mail content of the document.

22. The method of claim 19 wherein the document is a Web-page.

23. The method of claim 19 wherein the act of requesting at least one ad relevant to the e-mail content of the document includes constructing a URL that represents a request for at least one ad.

24. The method of claim 23 wherein the act of requesting at least one ad relevant to the e-mail content of the document further includes instantiating an ActiveX object that takes the URL and requests the at least one ad from a Web-based e-mail server that sourced the document.

25. The method of claim 19 wherein the document is a Web page, and wherein the act of rendering the at least one ad in association with the rendered e-mail content of the document includes manipulating a document object model of the Web page to render the ads.

26. The method of claim 19 wherein the act of rendering the at least one ad in association with the rendered document is done such that the document is not modified.

27. The method of claim 26 further comprising forwarding the document to another client, wherein the at least one ad is not rendered on the other client device.

28. The method of claim 19 wherein the act of rendering the at least one ad in association with the rendered document is done such that the at least one ad does not become a part of the document.

29. The method of claim 28 further comprising forwarding the document to another client, wherein the at least one ad is not rendered on the other client device.

30. The method of claim 19 wherein the document including e-mail content is an individual e-mail.

31. The method of claim 19 wherein the document including e-mail content is group of e-mails.

32. The method of claim 19 wherein the document including e-mail content is an e-mail thread.

33. The method of claim 19 wherein the document including e-mail content is a conversation view including a group of e-mails.

34. A method for facilitating the serving of advertisements with e-mail content, the method comprising:
a) accepting a request for a document including e-mail content;
b) generating a request identifier;
c) serving the requested document in association with the request identifier; and
d) obtaining at least one additional content item relevant to the e-mail content.

35. The method of claim 34 wherein the at least one additional content item is selected from a group consisting of (a) a news article, (b) an excerpt of a news article, (c) a search query, (d) a product review, and (e) an excerpt of a product review.

36. The method of claim 34 wherein the at least one additional content item includes at least one content relevant ad and at least one further additional content item selected from a group consisting of (a) a news article, (b) an excerpt of a news article, (c) a search query, (d) a product review, and (e) an excerpt of a product review.

37. The method of claim 34 further comprising:
e) storing the obtained at least one additional content item;
f) accepting an additional content item request;
g) reading the stored at least one additional content item using information from the additional item request; and
h) serving the at least one additional content item read.

38. The method of claim 37 wherein the at least one additional content item is selected from a group consisting of (a) a news article, (b) an excerpt of a news article, (c) a search query, (d) a product review, and (e) an excerpt of a product review.

39. The method of claim 37 wherein the at least one additional content item includes at least one content relevant ad and at least one further additional content item selected from a group consisting of (a) a news article, (b) an excerpt of a news article, (c) a search query, (d) a product review, and (e) an excerpt of a product review.

40. A method for facilitating the serving of advertisements with electronic messaging content, the method comprising:
a) accepting a request for a document including electronic messaging content;
b) generating a request identifier;
c) serving the requested document in association with the request identifier; and
d) obtaining at least one ad relevant to the electronic messaging content.

41. The method of claim 40 further comprising:
e) storing the obtained at least one ad;
f) accepting an ad request;
g) reading the stored at least one ad using information from the ad request; and
h) serving the at least one ad read.

42. The method of claim 40 wherein the electronic messaging content is content from one of (A) on-line groups, (B) blogs, (C) message postings, and (D) instant messaging.

43. A method for rendering ads in association with electronic messaging content, the method comprising:
a) requesting a document including electronic messaging content;
b) accepting the document;
c) rendering the document;
d) requesting at least one ad relevant to the electronic messaging content of the document;
e) receiving the at least one ad; and
f) rendering the at least one ad in association with the rendered document, wherein the at least one ad are rendered after the electronic messaging content of the document has already been rendered.

44. The method of claim 43 wherein the electronic messaging content is content from one of (A) on-line groups, (B) blogs, (C) message postings, and (D) instant messaging.

45. A method for facilitating the serving of advertisements with electronic messaging content, the method comprising:
a) accepting a request for a document including electronic messaging content;
b) generating a request identifier;
c) serving the requested document in association with the request identifier; and
d) obtaining at least one additional content item relevant to the electronic messaging content.

46. The method of claim 45 wherein the electronic messaging content is content from one of (A) on-line groups, (B) blogs, (C) message postings, and (D) instant messaging.

47. Apparatus for facilitating the serving of advertisements with e-mail content, the apparatus comprising:
a) an input for accepting a request for a document including e-mail content;
b) means for generating a request identifier;
c) means for serving the requested document in association with the request identifier; and
d) means for obtaining at least one ad relevant to the e-mail content.

48. The apparatus of claim 47 further comprising:
e) a storage facility for storing the obtained at least one ad;
f) means for accepting an ad request;
g) means for reading the stored at least one ad using information from the ad request; and
h) means for serving the at least one ad read.

49. The apparatus of claim 48 wherein the ad request was sourced by a client device when it rendered the requested document.

50. The apparatus of claim 48 wherein the ad request was sourced by a client device after it rendered the requested document.

51. The apparatus of claim 48 wherein the ad request was sourced by a browser when it rendered the requested document.

52. The apparatus of claim 48 wherein the ad request was sourced by a browser after it rendered the requested document.

53. The apparatus of claim 48 wherein the at least one ad stored includes the request identifier stored in association with the at least one ad.

54. The apparatus of claim 53 wherein the request identifier may be used as a primary key to lookup the associated at least one ad.

55. The apparatus of claim 53 wherein the ad request includes the request identifier.

56. The apparatus of claim 55 wherein the means for reading the stored at least one ad using information from the ad request use the request identifier to lookup the associated at least one ad.

57. The apparatus of claim 47 wherein the means for serving the requested document in association with the request identifier is a first thread, and wherein the means for obtaining at least one ad relevant to content of the e-mail is a second thread.

58. The apparatus of claim 57 wherein the execution of the first thread is independent of the execution of the second thread.

59. The apparatus of claim 47 wherein the means for obtaining at least one ad relevant to content of the e-mail include means for submitting an ad request to a content-relevant ad server.

60. The apparatus of claim 59 wherein the ad request includes the request identifier.

61. The apparatus of claim 47 wherein the document including e-mail content represents an individual e-mail message.

62. The apparatus of claim 47 wherein the document including e-mail content represents a group of e-mail messages.

63. The apparatus of claim 47 wherein the document including e-mail content represents an e-mail thread output as a conversation.

64. The apparatus of claim 47 wherein the document including e-mail content is a conversation view including a group of e-mails.

65. Apparatus for rendering ads in association with e-mail content, the apparatus comprising:
a) means for requesting a document including e-mail content;
b) means for accepting the document;
c) means for rendering the document;
d) means for requesting at least one ad relevant to the e-mail content of the document;
e) means for receiving the at least one ad; and
f) means for rendering the at least one ad in association with the rendered document, wherein the at least one ad are rendered after the e-mail content of the document has already been rendered.

66. The apparatus of claim 65 wherein the accepted document includes a request identifier and wherein the means for requesting at least one ad relevant to the e-mail content of the document include means for generating a request including the request identifier.

67. The apparatus of claim 65 wherein the means for requesting requests the at least one ad relevant to the e-mail content of the document after the means for rendering renders the e-mail content of the document.

68. The apparatus of claim 65 wherein the document is a Web-page.

69. The apparatus of claim 65 wherein the means for requesting at least one ad relevant to the e-mail content of the document include means for constructing a URL that represents a request for at least one ad.

70. The apparatus of claim 69 wherein the means for requesting at least one ad relevant to the e-mail content of the document further include means for instantiating an ActiveX object that takes the URL and requests the at least one ad from a Web-based e-mail server that sourced the document.

71. The apparatus of claim 65 wherein the document is a Web page, and wherein the means for rendering the at least one ad in association with the rendered e-mail content of the document include means for manipulating a document object model of the Web page to render the ads.

72. The apparatus of claim 65 wherein the means for rendering the at least one ad in association with the rendered document does not modify the document.

73. The apparatus of claim 72 further comprising means for forwarding the document to another client, wherein the at least one ad is not rendered on the other client device.

74. The apparatus of claim 65 wherein the means for rendering the at least one ad in association with the rendered document does not make the at least one ad become a part of the document.

75. The apparatus of claim 74 further comprising means for forwarding the document to another client, wherein the at least one ad is not rendered on the other client device.

76. The apparatus of claim 65 wherein the document including e-mail content is an individual e-mail.

77. The apparatus of claim 65 wherein the document including e-mail content is group of e-mails.

78. The apparatus of claim 65 wherein the document including e-mail content is an e-mail thread.

79. The apparatus of claim 65 wherein the document including e-mail content is a conversation view including a group of e-mails.

80. Apparatus for facilitating the serving of advertisements with e-mail content, the apparatus comprising:
a) means for accepting a request for a document including e-mail content;
b) means for generating a request identifier;
c) means for serving the requested document in association with the request identifier; and
d) means for obtaining at least one additional content item relevant to the e-mail content.

81. The apparatus of claim 80 wherein the at least one additional content item is selected from a group consisting of (a) a news article, (b) an excerpt of a news article, (c) a search query, (d) a product review, and (e) an excerpt of a product review.

82. The apparatus of claim 80 wherein the at least one additional content item includes at least one content relevant ad and at least one further additional content item selected from a group consisting of (a) a news article, (b) an excerpt of a news article, (c) a search query, (d) a product review, and (e) an excerpt of a product review.

83. The apparatus of claim 80 further comprising:
e) means for storing the obtained at least one additional content item;
f) means for accepting an additional content item request;
g) means for reading the stored at least one additional content item using information from the additional item request; and
h) means for serving the at least one additional content item read.

84. The apparatus of claim 83 wherein the at least one additional content item is selected from a group consisting of (a) a news article, (b) an excerpt of a news article, (c) a search query, (d) a product review, and (e) an excerpt of a product review.

85. The apparatus of claim 83 wherein the at least one additional content item includes at least one content relevant ad and at least one further additional content item selected from a group consisting of (a) a news article, (b) an excerpt of a news article, (c) a search query, (d) a product review, and (e) an excerpt of a product review.

86. Apparatus for facilitating the serving of advertisements with electronic messaging content, the apparatus comprising:
a) means for accepting a request for a document including electronic messaging content;
b) means for generating a request identifier;
c) means for serving the requested document in association with the request identifier; and
d) means for obtaining at least one ad relevant to the electronic messaging content.

87. The apparatus of claim 86 further comprising:
e) means for storing the obtained at least one ad;
f) means for accepting an ad request;
g) means for reading the stored at least one ad using information from the ad request; and
h) means for serving the at least one ad read.

88. The apparatus of claim 86 wherein the electronic messaging content is content from one of (A) on-line groups, (B) blogs, (C) message postings, and (D) instant messaging.

89. Apparatus for rendering ads in association with electronic messaging content, the apparatus comprising:
a) means for requesting a document including electronic messaging content;
b) means for accepting the document;
c) means for rendering the document;
d) means for requesting at least one ad relevant to the electronic messaging content of the document;
e) means for receiving the at least one ad; and
f) means for rendering the at least one ad in association with the rendered document, wherein the at least one ad are rendered after the electronic messaging content of the document has already been rendered.

90. The apparatus of claim 89 wherein the electronic messaging content is content from one of (A) on-line groups, (B) blogs, (C) message postings, and (D) instant messaging.

91. Apparatus for facilitating the serving of advertisements with electronic messaging content, the apparatus comprising:
a) means for accepting a request for a document including electronic messaging content;
b) means for generating a request identifier;
c) means for serving the requested document in association with the request identifier; and
d) means for obtaining at least one additional content item relevant to the electronic messaging content.

92. The apparatus of claim 91 wherein the electronic messaging content is content from one of (A) on-line groups, (B) blogs, (C) message postings, and (D) instant messaging.
